(19) United States
(12) Patent Application Publication
(10) Pub. No.: US 2019/0304220 A1
(43) Pub. Date: Oct. 3, 2019

(54) SYSTEMS AND METHODS FOR MONITORING AND CONTROLLING ACCESS TO A SECURED AREA

(71) Applicant: TOTAL AUTOMATION GROUP, INC., Trafford, AL (US)

(72) Inventors: STEPHEN MICHAEL LEE, Pinson, AL (US); JARRETT THOMAS ROSE, Pinson, AL (US)

(21) Appl. No.: 16/372,040

(22) Filed: Apr. 1, 2019

Related U.S. Application Data
(60) Provisional application No. 62/650,886, filed on Mar. 30, 2018.

(51) Int. Cl. G07C 9/00; E01F 13/06; G08G 1/04; G01S 15/04

(52) U.S. Cl. CPC G07C 9/00166; G01S 15/04; G08G 1/04; E01F 13/06

(57) ABSTRACT

Systems and methods for monitoring and controlling access to a secured area are disclosed. A moveable barrier may be used in conjunction with one or more types of sensors and a logic unit to monitor and control access to the secured area. The barrier may permit access to the secured area when a set of access parameters are satisfied. A user at a human-machine interface may remotely communicate with persons detected at the secured area.

### CROSS REFERENCE TO RELATED APPLICATION

This application claims priority to provisional U.S. application Ser. No. 62/650,886, filed Mar. 30, 2018, which is herein incorporated by reference in its entirety.

### BACKGROUND

Monitoring and controlling access to a secured area can be achieved using a variety of equipment configurations. At entry points to secured areas where vehicles travel, a typical configuration may include one or more sensors near an entry point that are used to detect when vehicles approach entry point barriers. When a vehicle is detected an access level can be determined based on a range of access parameters. Additionally, the sensors may be used to monitor for pedestrian traffic near the entry point barriers. Existing systems lack the ability to provide security personnel with easy-to-access real-time information about vehicles and persons detected. Having access to such information could allow personnel to more effectively ensure the area remains secure while also safeguarding pedestrians near entry points. These and other shortcomings are addressed by the systems and methods described herein.

### SUMMARY

It is to be understood that both the following general description and the following detailed description are exemplary and explanatory only and are not restrictive. Provided are systems and methods for monitoring and controlling access to a secured area.

In an example configuration of the systems described herein, one or more entry barriers along with several sensors of various types and at various placements can be used to monitor and control access to entry points of a secured area. The sensors can be configured to detect when objects, such as vehicles or persons, are proximate to one or more of the entry points and to collect data related to one or more attributes of detected object(s). Additionally, one or more cameras can be installed at several locations within and surrounding the secured area in order to provide a video stream to a user interface showing the detected object(s). The cameras can be equipped with microphones to provide an audio stream to the user interface, and, optionally, to broadcast audio from the camera's location. The audio that is broadcast can originate from the user device. Further, the sensors may be connected to a control unit, such as a programmable logic unit, which can receive the data collected by the sensors and cause the entry point barrier to block or to permit access to the entry point. The control unit may determine whether to block or to permit access based on a set of access parameters stored on a memory and/or the one or more attributes of the object. The control unit may also be in communication with the user device, thereby allowing a user of the user device to determine whether to block or to permit access to the entry point.

In other examples, a method may be used to monitor and control access to a secured area. The method begins by detecting a presence of an object, such as a vehicle or a person, proximate to an entry point barrier to the secured area. The detection may be achieved using a plurality of sensors connected to a logic unit, whereby the logic unit receives data from the plurality of sensors and makes a determination that an object is present. In response to detecting an object, an audio and/or video signal can be transmitted to a user device by one or more audio devices and/or one more video devices located near the entry point. Further the logic unit may be used to determine a plurality of attributes of the object and/or one or more access parameters. Using the plurality of access parameters and/or one or more of the plurality of attributes, the logic unit can determine an access level for the object. Based on the determined access level, the logic unit may cause a barrier at the entry point to obstruct or not to obstruct the object from passing through the entry point. Alternatively, or in addition, the logic unit may be in communication with a user device, which could permit a user to determine whether the object should be permitted to enter the secured area.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the systems and methods:

FIG. 1 is a diagram of an exemplary monitoring and access control system;

FIG. 2A is an exemplary user device;

FIG. 2B is a view of an exemplary user device;

FIG. 2C is a view of an exemplary user device;

FIG. 2D is a view of an exemplary user device;

FIG. 2E is a view of an exemplary user device;

FIG. 2F is a view of an exemplary user device;

FIG. 3 is a view of an exemplary user device;

FIG. 4 is a flowchart of an exemplary method;

FIG. 5 is a block diagram of an exemplary operating environment; and

FIG. 6 is a block diagram illustrating an exemplary user device.

### DETAILED DESCRIPTION

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed systems and methods. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all systems and methods. This applies to all aspects of this disclosure including, but not limited to, steps in disclosed methods. Thus, if there are a variety of additional steps that can be performed it is understood that each of these additional steps can be performed with any specific embodiment or combination of embodiments of the disclosed methods. The present systems and methods may be understood more readily by reference to the following detailed description of preferred embodiments and the examples included therein and to the Figures and their previous and following description.

As will be appreciated by one skilled in the art, the systems and methods may take the form of an entirely hardware embodiment, an entirely software embodiment, or an embodiment combining software and hardware aspects. Furthermore, the systems and methods may take the form of a computer program product on a computer-readable storage medium having computer-readable program instructions (e.g., computer software) embodied in the storage medium. More particularly, the present systems and methods may take the form of specialized computer software executed by a processor of a computer, connected by wired or wireless means to a closed network, that is in communication with a programmable logic unit. Any suitable computer-readable storage medium may be utilized including hard disks, CD-ROMs, optical storage devices, or magnetic storage devices.

Embodiments of the systems and methods are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus, such as, for example, a programmable logic unit, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Disclosed herein are systems and methods for monitoring and controlling access to a secured area. With an example system, metallic objects, such as vehicles, entering or exiting a secured area can be monitored by a plurality of sensors. The sensors can be configured by a control unit, such as a programmable logic unit, to collect data relating to one or more physical characteristics and/or movement of a detected object, including, for example, a length, width, height, weight, and a velocity of the detected object. Additionally, along with the sensors and the control unit, one or more barriers situated at one or more entry points to the secured area may be used to control access to objects detected proximate to the secured area. The barriers may be moveable, such as an arm-type barrier, a door, a slide gate, a bi-fold gate, a swing gate, a wedge, or the like. The control unit can be configured to cause one or more of the barriers to block access to the secured area when a detected object, such as a vehicle, is near an entry point and does not satisfy a set of access parameters. The access parameters may be stored on a memory of the control unit, and they may include, by way of example, the one or more physical characteristics of the detected object and/or one or more acceptable velocities of the detected object (e.g., only vehicles of a certain size may enter the secured area).

Several varieties of sensors may be used. For example, one or more sensors of the plurality of sensors may be inductive-loop sensors, which detect metallic objects, such as vehicles. The inductive-loop sensors can be placed, for example, on either side of the barrier at the entry point. Optionally, if two or more barriers are used (e.g., an arm-type barrier may be located in front of a wedge type barrier), an inductive-loop sensor may be placed at each barrier on one or both sides. Other example sensors include one or more ultrasonic transducers installed near the entry point, which can detect an object's presence using sonic pulses. In a further example, one or more weight sensors can be used. The one or more weight sensors may be buried underneath a roadway or a point of ingress and/or egress near one or more entry points. In still a further example, one or more infrared sensors can be used, which may be configured by the control unit to determine a number of persons inside vehicles proximate to the one or more infrared sensors. All sensors can be capable of collecting data and transmitting it, through wired or wireless means, to the control unit, which can use the data when determining whether an object or person that is detected may enter the secured area.

In addition to the plurality of sensors, one or more cameras may be installed at several locations surrounding one or more entry points to the secured area. The cameras may be in communication with the control unit, which can transmit one or more video streams from one or more cameras to a user device, such as a human-machine interface with a touchscreen. The user device can be operated by a user (e.g., security personnel, custodians, law enforcement, etc.), and it can allow for the user to interact with one or more persons visible in the video stream via one or more audio devices that can be installed near one or more of the entry points and/or throughout the secured area. In some examples, the one or more cameras each comprise an audio device capable of recording audio via a microphone and broadcasting audio via a speaker.

Additionally, a card reader can be used in conjunction with the plurality of sensors and/or the one or more cameras to monitor and control access to the secured area. For example, a vehicle may approach a card reader located near an entry point, and an inductive-loop sensor installed near the card reader may detect the vehicle's presence. In response to the detection of the vehicle, the control unit may cause the card reader to power on and/or initialize. The vehicle driver may then place his or her credentials (e.g., a proximity credential, such as an RFID card, or the like) near the card reader, and, in response, the card reader sends the credential information to the control unit, which can use the access parameters (e.g., vehicle size and/or weight; number of occupants; proper security level, etc.) stored in memory to determine whether the driver is authorized to enter the area. The driver and/or the vehicle, via one or more video streams transmitted by the one or more cameras, can be displayed at the user device following the card reader receiving the credential information. After a determination has been made regarding whether the vehicle is authorized to enter, the control unit may cause the entry point barrier to move to a position such that the vehicle can pass through the entry point and into the secured area. For example, the barrier at the card reader may be an arm-type barrier, which is raised after the vehicle/driver is authorized to enter. In contrast, following a determination that an object or vehicle is not authorized to enter, the control unit may cause the entry point barrier to move to a position such that the object or vehicle cannot pass through the entry point and into the secured area.

Continuing with the previous example, a second barrier may be located after the arm-type barrier. The second barrier may be, for example, a wedge-type barrier capable of withstanding impacts having a large magnitude of force. After the arm of the arm-type barrier is raised, the vehicle can proceed forward up to the wedge-type barrier. At that point, an inductive-loop sensor located in front of the wedge-type barrier may detect the vehicle, and the control unit, having already determined that the vehicle/driver is authorized to enter, may cause the wedge-type barrier to lower and allow the vehicle to enter the secured area. As the vehicle enters the secured area, an additional inductive-loop sensor, which may be located within the secured area and near the wedge-type barrier, may detect the vehicle as it passes over the sensor's loops, and the inductive-loop sensors located outside the secured area (e.g., at the card reader and/or at the arm-type barrier) may no longer detect the vehicle's presence. In response to data received from the sensors indicating that the vehicle has moved past both barriers, the control unit may cause the arm of the arm-type barrier to lower and the wedge-type barrier to move back to its previous position (e.g., blocking access to the secured area). Further, prior to causing any barrier to move, the control unit, via one or more of the audio devices located near the barrier, may cause the one or more audio devices to broadcast an alert to inform persons nearby that the barrier is going to open or close (e.g., a recorded warning with instructions and/or a siren).

In addition to the system described above, a method may be used to monitor and control access to a secured area. The method can be used to detect a presence of an object, such as a vehicle or a person, proximate to an entry point barrier to the secured area. The detection may be achieved using a plurality of sensors connected to a logic unit, whereby the logic unit receives data from the plurality of sensors and makes a determination that an object is present. The sensors may be inductive-loop sensors, which detect metallic objects, such as vehicles; ultrasonic transducers installed near the entry point; weight sensors buried underneath a roadway or a point of ingress and/or egress near one or more entry points; and/or one or more infrared sensors configured by the control unit to determine a number of persons inside a vehicle proximate to the one or more infrared sensors. Regardless of the type of sensors used, they may all be capable of collecting data and transmitting it, through wired or wireless means, to the logic unit, which can use the data when determining whether an object or person that is detected is authorized to enter the secured area. In response to detecting an object, an audio and/or video signal can be transmitted to a user device by one or more audio devices and/or one more video devices located near the entry point. The user device can allow a user to view detected objects and/or persons, grant or deny detected objects and/or persons access to the secured area, communicate with detected objects and/or persons, and the like. Further, the logic unit may be used to determine a plurality of attributes of the detected objects and/or persons as well as one or more access parameters that can be stored on a memory of the logic unit. Using the plurality of access parameters and/or one or more of the plurality of attributes, the logic unit can determine an access level for the detected objects and/or persons. Based on the determined access level, the logic unit may cause one or more barriers at or nearby the entry point to obstruct or not to obstruct the detected objects and/or persons from passing through the entry point.

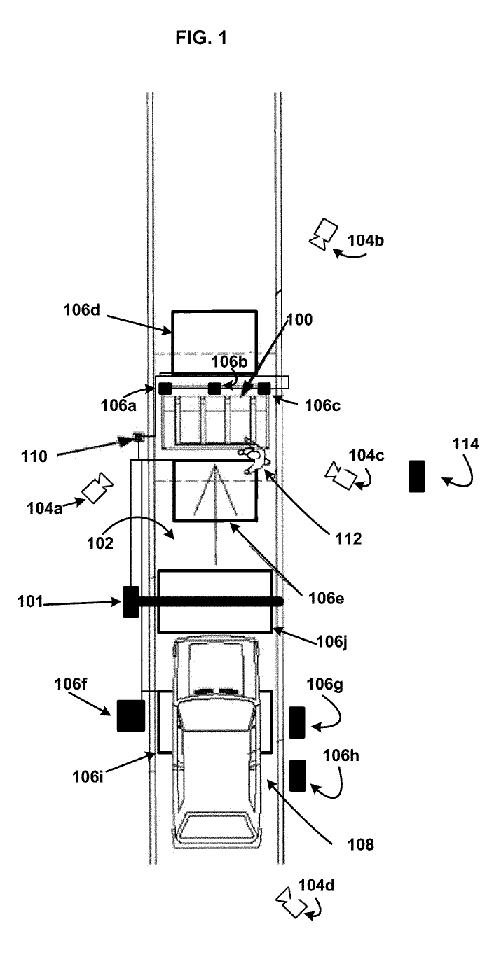

Turning now to FIG. 1, an example configuration of a monitor and access control system is depicted. One or more barriers 100,101 can be placed at an entry point 102 to a secured area in order to control access to the secured area. A plurality of sensors 106a,b,c,d,e,f,g,h,i,j can be situated proximate to the barriers 100,101 and/or the entry point 102. The plurality of sensors 106a,b,c,d,e,f,g,h,i,j can be configured by a control unit 110 (e.g., a computing device with an integrated programmable logic unit) to collect data relating to one or more physical characteristics and/or movement of a detected object, including, for example, a length, width, height, weight, and/or a velocity of the detected object. The one or more barriers 100,101 may be moveable, such as arm-type barriers, doors, slide gates, bi-fold gates, swing gates, wedges, or the like. The control unit 110 can be configured to cause the one or more barriers 100,101 to block access to the secured area when a detected object, such as a vehicle 108 or a person 112, is near the entry point 102 and does not satisfy a set of access parameters. The access parameters may be stored on a memory of the control unit 110, and they may include, by way of example, the one or more physical characteristics of the detected object and/or one or more acceptable velocities of the detected object (e.g., only vehicles of a certain size may enter the secured area).

Several varieties of sensors among the plurality of sensors 106a,b,c,d,e,f,g,h,i,j may be used. For example, sensors 106d,e,i and j may be inductive-loop sensors, which can be situated adjacent to the entry point 102 (e.g., on one or both sides of the one or more barriers 100,101) and interconnected by a conductive material, such as copper wiring forming one or more loops. As a metallic object moves across or nearby any one of the sensors 106d,e,i and j, a change in electrical current flowing through the one or more loops can be detected and data relating to the metallic object, such as a frequency signature indicative of a vehicle type, can be transmitted to the control unit 110. The control unit 110 can use the data to determine (e.g., with the access parameters and/or software stored on a memory) whether the frequency signature corresponds to a vehicle that, per the access parameters, cannot access the secured area (e.g., certain trucks and/or vans may be too large to safely enter).

Other example sensors that can be used are one or more ultrasonic transducers 106a,b,c installed near the entry point 102 (e.g., attached to a wall, edifice, pole, etc.) and/or affixed to the one or more barriers 100,101. The one or more ultrasonic transducers 106a,b,c can detect an object's presence using sonic pulses. A series of sonic pulses can be emitted that originate from the ultrasonic transducers 106a,b,c and propagate in one or more directions away from the entry point and the one or more barriers 100,101. One or more sonic pulses of the series of sonic pulses may encounter a solid object and begin propagating back toward the respective ultrasonic transducer 106a,b,c from which the one or more sonic pulses originated. Data collected by the one or more ultrasonic transducers 106a,b,c relating to the one or more sonic pulses can be received by the control unit 110 and used to determine a time between the emission of the series of sonic pulses and the return of the one or more sonic pulses, thereby determining both a direction of travel and a distance that the solid object is from the entry point 102 barriers 100,101. For example, the control unit 110 may receive three sets of data collected by the one or more ultrasonic transducers 106a,b,c over a 1.5 second timeframe, wherein each set of data is collected a half-second apart (e.g., many sonic pulses may be emitted and received in each half-second timeframe). The first set of data may be used to determine that a person 112 is 10 feet from a moveable barrier 100 that is about to, or in the process, of moving in such a way to be a danger to the person 112 (e.g., the person 112 may accidentally be impacted by the moveable barrier 100 as it is opening, closing, sliding, etc.). It may then be determined from the second set of data that the person 112 is now 8 feet away from the moveable barrier 100 and is moving in a directing of travel toward the moveable barrier 100 (e.g., based on the distance determined with the first set of data and the distance determined with the second set of data). The third set of data may indicate the person 112 is now only 6 feet away from the moveable barrier 100. In response to determining the person 112 is only 6 feet away, the control unit 110, based on an access parameter of the plurality of access parameters, may immediately cause the moveable barrier 100 to either begin moving in a direction that is opposite of its current direction of travel or to cease moving and stay in place. Simultaneously, the control unit 110 may cause an alarm to be sounded by one or more speakers located proximate to the moveable barrier 100 and/or cause one or more warning lights installed on or near the moveable barrier 100 to illuminate in such a way as to alert the person 112.

In a further example, one or more of the sensors 106d,e,i and j may be weight sensors buried underneath a roadway or a point of ingress and/or egress near the entry point 102. As an object passes over one or more of the sensors 106d,e,i and j, a weight of the object can be determined at the control unit 110 in communication with sensors the one or more of the sensors 106d,e,i and j, and the weight may be used as an access parameter of the plurality of access parameters. In still a further example, one or more infrared sensors 106g and 106h can be used, which may be configured by the control unit 110 to determine a number of persons inside a vehicle 108 proximate to the one or more infrared sensors 106g and 106h. Optionally, an access parameter of the plurality of access parameters may be a predetermined number of vehicle 108 occupants.

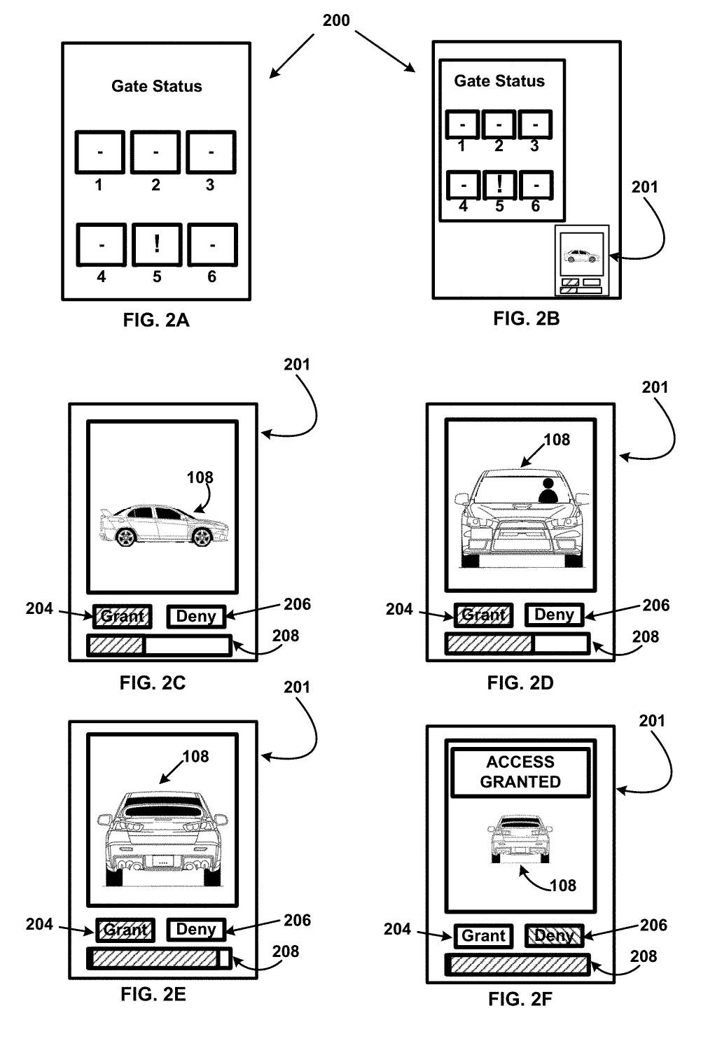

In addition to the plurality of sensors, one or more cameras 104a,b,c,d may be installed at several locations surrounding the entry point 102 to the secured area. The cameras 104a,b,c,d may be in communication with the control unit 110, which can transmit one or more video streams from one or more cameras 104a,b,c,d to a user device, such as a human-machine interface with a touchscreen. FIG. 2A depicts a user device 200 with a default display to indicate a status of the one or more barriers 100,101 at each of one or more entry points 102 (e.g., whether an object is present, a position of a barrier located at a respective entry point, etc.). The default display can include controls for the one or more barriers 100,101 (e.g., buttons the user can press to open, close, or stop the one or more barriers 100,101). The user device 200 may be a human-machine interface (e.g., a touchscreen computer; a tablet; a mobile device; and the like) that is in communication with the control unit 110, the one or more cameras 104a,b,c,d and/or the one or more sensors 106a,b,c,d,e,f,g,h,i,j. Further, the user device 200 may be designed or programmed (e.g., with specialized software) to allow a user without expert training to interact with the control unit 110, the one or more cameras 104a,b,c,d and/or the one or more sensors 106a,b,c,d,e,f,g,h,i,j with a graphical user interface.

When an object or person 112 is detected, the control unit 110 may cause the user device 200 display to change, as depicted in FIG. 2B, to a video stream 201 showing the object or person detected. The user device 200 can be operated by a user (e.g., security personnel, custodians, law enforcement, etc.), and it can allow for the user to interact with one or more persons 112 visible in the video stream 201 via one or more audio devices 114 installed at the entry point 102 and/or throughout the secured area. The audio devices 114 can be capable of transmitting audio captured with an integrated microphone as well as receiving audio to be broadcast with an integrated speaker. In some examples, the audio devices 114 may be integrated into the one or more cameras 104a,b,c,d. The captured audio can be transmitted from the originating audio device 114 to the user device 200, where the user can hear the audio in real-time as it is captured. Further, the user device 200, with an integrated microphone, can be used to transmit audio (e.g., the user's voice, a recording, etc.) to be broadcast at one or more of the audio devices 114 (e.g., the audio device closet to one or more persons shown in the video stream).

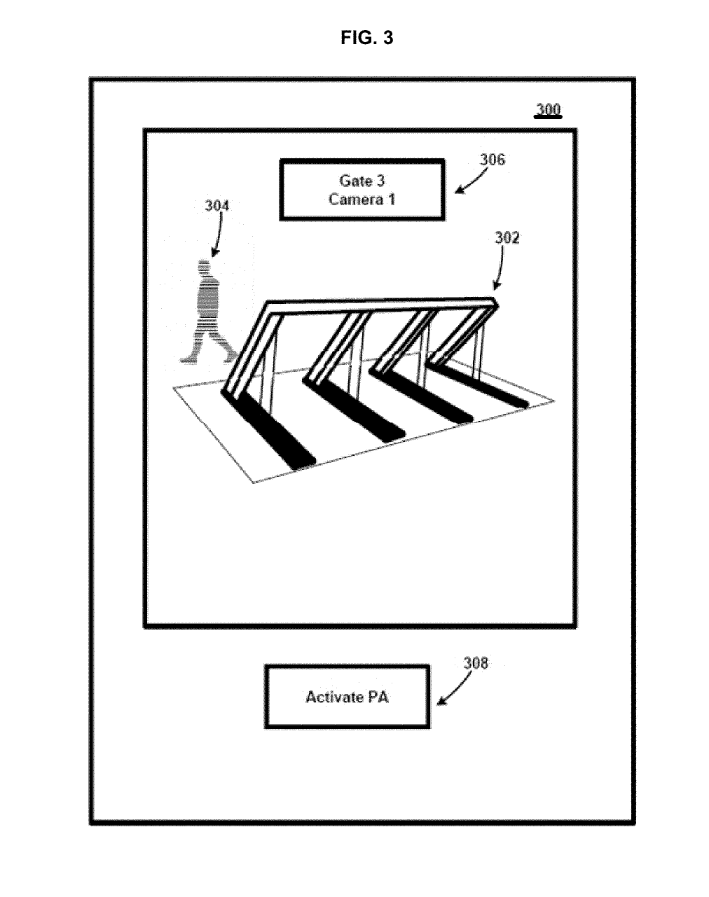

Turning now to FIG. 3, a pedestrian alert view 300 of the user device 200 is depicted. After determining that a person 304 is present near a barrier 302 and/or an entry point 102 (e.g., using data received from one or more sensors, weight sensors, or the like), the control unit 110 may cause the user device 200 to automatically display pedestrian alert view 300 so that a user can take proper action. For example, if the user device 200 is currently on the default display showing the status and/or control options for the one or more barriers 100,101 and/or the barrier 302, the control unit 110, upon determining that a person 304 is present near a barrier 302, may cause the user device 200 to immediately display pedestrian alert view 300. The pedestrian alert view 300 can provide location information 306 of the barrier 302 and the person 304 (e.g., a number/name of an entry point at which the barrier 302 is located, such as “Gate 3”). By pressing button 308, the user can transmit audio (e.g., the user's voice) directly to the person 302 using a microphone integrated in the user device 200. The user device 200 may transmit the audio to the control unit 110, which in turn can determine which audio device 114 is closest to the person 304. In some examples, the one or more cameras 104a,b,c,d may have an integrated audio device 114 that can broadcast the audio transmitted from the user device 200 through an integrated speaker so that the person 304 can hear the audio. Further, the integrated audio devices 114 of the one or more cameras 104a,b,c,d may also have an integrated microphone to permit the person 304 to respond to the user in real-time (e.g., the integrated microphone will transmit captured audio in real-time to the user device 200, which can use an integrated speaker to play the audio for the user).

Returning to FIG. 1, in some examples, a sensor 106f may be a card reader that can be used in conjunction with the other sensors 106a,b,c,d,e,g,h,i,j and/or the one or more cameras 104a,b,c,d to monitor and control access to the secured area. For example, a vehicle 108 may approach the card reader (e.g., sensor 106f) and a display coupled to the card reader (e.g., sensor 106f) may show a message requesting that the vehicle 108 driver place his or her access card (e.g., an RFID card, an HID card, a smart card, etc.) near the card reader. In response the card reader may send the access card's credential information to the control unit 110, which can determine (e.g., with software and access parameters stored in a memory) whether the driver is authorized to enter the area (e.g., an employee of a company located at the secured area, a tenant of a building with a secured parking lot, etc.). In other examples, the display of the card reader (e.g., sensor 106f) may also request that any other occupants in the vehicle present his or her access card as well (e.g., place his or her access card near the card reader), and each occupant's credential information can then be analyzed in a similar manner as the driver's. The authorization for the driver, and any occupants, to enter the secured area may be determined by a set of authorized entrant data (e.g., access parameters) stored in the memory of the control unit 110. In one example, the card reader may alert the user device 200 that a person is seeking entry and provide the user device 200 with the credential information (e.g., a name stored on the card). At the user device 200, the user could send an authorization or a denial message to the card reader via control unit 110. In other examples, the control unit 110 determines whether the credential information is valid without any interaction from the user 200. Further, if there are passengers in the vehicle, the each person's individual credential information can be received and access privileges can be determined for each occupant in a similar fashion as for the driver.

In another example, the control unit 110 may use the credential information along with one or more attributes of the vehicle 108 when determining whether the driver, and occupants, if any, is authorized to enter. For instance, the vehicle's 108 weight, height, length, width, or the like, may be considered (e.g., using one or more sensors located near the card reader). Also, using data from the one or more infrared sensors 106g,h, a number of occupants in the vehicle 108 in addition to the driver may be considered (e.g., one more access parameters may prohibit bringing guests to the secured area). Further, one or more of the cameras 104a,b,c,d may be installed near the card reader such that the vehicle's 108 occupants can be viewed (e.g., FIG. 2D, which shows a camera's view of a single occupant) and images of the occupants can be captured in a video stream and transmitted to the user device 200. The user, at the user device 200, viewing the occupants may determine that the vehicle is not permitted to enter (e.g., a photograph displayed on the user device 200 after an occupant presents his or her credential information at the card reader may not match the person the user sees in the video stream). Alternatively, or in addition, specialized software stored on a memory of the user device 200 and/or the control unit 110 (e.g., software using facial recognition technology) may analyze a frame or frames of the video stream showing the vehicle occupants (e.g., the occupant in FIG. 2D may be determined to match a photograph stored in memory that is associated with the occupant's received credential information) and then determine whether the vehicle and occupant(s) are authorized to enter (e.g., all occupants are determined to be the persons depicted in photographs stored in the memory and associated with the received credential information).

Further, one or more images of the vehicle's 108 license plate can be captured by one or more of the cameras 104a,b,c,d, which are then transmitted to the user device 200. The user, at the user device 200, viewing the one or more images of the license plate may determine that the vehicle is not permitted to enter (e.g., the license plate number is not associated with any vehicle(s) listed in the received credential information from the driver). Alternatively, or in addition, specialized software stored on a memory of the user device 200 (e.g., software using optical character recognition technology) may analyze a frame or frames of the video stream showing the license plate (e.g., captured by the one or more of the cameras 104a,b,c,d located near the card reader) and then determine whether the license plate information corresponds to an authorized entrant (e.g., the license plate number is associated with a vehicle(s) listed in the received credential information from the driver).

Returning to FIG. 2, various stages of the process for determining whether the driver and/or the vehicle 108 are authorized to enter may be displayed at the user device 200. As described above, the user device's 200 default display, shown in FIG. 2A, may indicate a status of the one or more barriers 100,101 at one or more entry points 102 (e.g., whether an object is present, a position of a barrier located at the entry point, etc.). When the card reader (e.g., sensor 106f) receives the credential information, the user device 200 may automatically open a separate window showing a video stream 201 of the vehicle 108 from one or more vantage points (e.g., a side view, a top view, a front view, a rear view, etc.). Alternatively, if an inductive-loop sensor 106i is located near the card reader, then the separate window may open automatically when the vehicle 108 is detected by the sensor. The video stream 201 may change vantage points at different stages of the authorization process. FIG. 2C depicts a side view of the vehicle 108 as well as a grant button 204, a deny button 206, and a status bar 208. The grant button 204 may be grayed out because the control unit 110 and/or the user has not yet determined whether the vehicle 108 may enter. At any time the user may press the deny button 206 (e.g., the vehicle is recognized to be an immediate threat) but the user cannot override the control unit 110 by pressing the grant button 204 (e.g., the user is not authorized to circumvent an authorization protocol being implemented by the control unit 110). In other examples, the user may be permitted to override the control unit 110 at any time during the process by pressing the grant button 204 (e.g., the user has discretion when determining whether a vehicle/driver is authorized to enter the secured area). After the control unit 110 determines that the credential information matches an entry in the authorized entrant data (e.g., the name stored on the card is listed in the authorized entrant data), the vantage point of video stream 201 may change to a front view (e.g., vantage point of one or more of the infrared sensors that are collecting data regarding a number of vehicle occupants), as shown in FIG. 2D, and the status bar 208 may indicate that a certain percentage of the process is complete.

Next, if the number of vehicle 108 occupants is determined not to violate the access parameters, then the vantage point of video stream 201 may change to a rear view (e.g., vantage point of one or more of the cameras that can capture an image of the license plate), as shown in FIG. 2E. At this point in the authorization process, the status bar 208 may indicate that the process is almost complete, and a weight of the vehicle 108 may be determined. Using information determined from the license plate information, such as a make and a model of the vehicle 108, the control unit 110 may determine a standard weight for the vehicle's 108 model based on data stored in memory (e.g., a dataset comprising individual vehicle weights). The standard weight for the vehicle's 108 model can then be compared against an observed weight, which may be the sum of a weight of the vehicle 108 model associated with the license plate (e.g., model of vehicle registered with security personnel with the license plate number) plus a weight of a cardholder(s) associated with the presented access card(s) (e.g., a weight of each person associated with each presented access card). If the observed weight is not within an accepted tolerance range (e.g., plus or minus 100 pounds), which can be stored on the memory of the control unit 110, then the control unit 110 may determine that the vehicle 108 is not authorized and/or display an alert on the user device 200 (e.g., possible additional occupants or objects in the vehicle that were not observed with the one or more infrared devices and/or other sensors).On the other hand, if the observed weight is within the accepted tolerance range, then the authorization process may complete and the vehicle 108 is determined to be authorized to enter. Simultaneously, the vantage point of video stream 201 on the user device 200 may change to a vantage point showing the vehicle 108 entering the secured area, as shown in FIG. 2F, and the status bar 208 may indicate that the process is complete.

In some examples, a barrier 101 (e.g., an arm-type barrier) is located near the card reader (e.g., sensor 106f). Following a determination that an object or vehicle 108 is authorized to enter, the control unit 110 may cause the barrier 101 to move to a position such that the object or vehicle 108 can pass through the entry point 102 and into the secured area (e.g., an arm of the arm-type barrier is raised). In contrast, following a determination that an object or vehicle 108 is not authorized to enter, the control unit 110 may cause the barrier 101 to move to a position such that the object or vehicle 108 cannot pass through the entry point 102 and into the secured area (e.g., the arm of the arm type barrier is lowered). Optionally, a barrier 100 may be located at a position that is past the barrier 101 located near the card reader. The barrier 100 may be, for example, a wedge-type barrier that is capable of withstanding vehicle 108 impacts.

After the barrier 101 is moved to an open position (e.g., the arm of the arm-type barrier is raised), the vehicle 108 can proceed forward up to the wedge-type barrier 100. At that point, an inductive-loop sensor 106e located in front of the wedge-type barrier 100 may detect the vehicle 108, and the control unit 110, having already determined that the vehicle 108 is authorized to enter, may cause the wedge-type barrier 100 to lower and allow the vehicle 108 to enter the secured area. As the vehicle 108 enters the secured area, an additional inductive-loop sensor 106d, which may be located within the secured area but still near the wedge-type barrier 100, may detect the vehicle 108 as it passes over the sensor's 106d loops, and the inductive-loop sensors located outside the secured area (e.g., sensor 106i at the card reader and/or sensor 106j at the arm-type barrier) may no longer detect the vehicle's 108 presence. In response, the control unit 110 may cause the barrier 101 to move to a closed position and the wedge-type barrier 100 to move back to its previous position (e.g., blocking access to the secured area). Further, prior to causing the barrier 100 and/or the barrier 101 to move, one or more of the audio devices 114 located near the barrier 100 and/or the barrier 101 may broadcast an alert to inform persons 112 nearby that the barrier 100 and/or the barrier 101 is (are) going to open or close (e.g., a recorded warning with instructions and/or a siren).

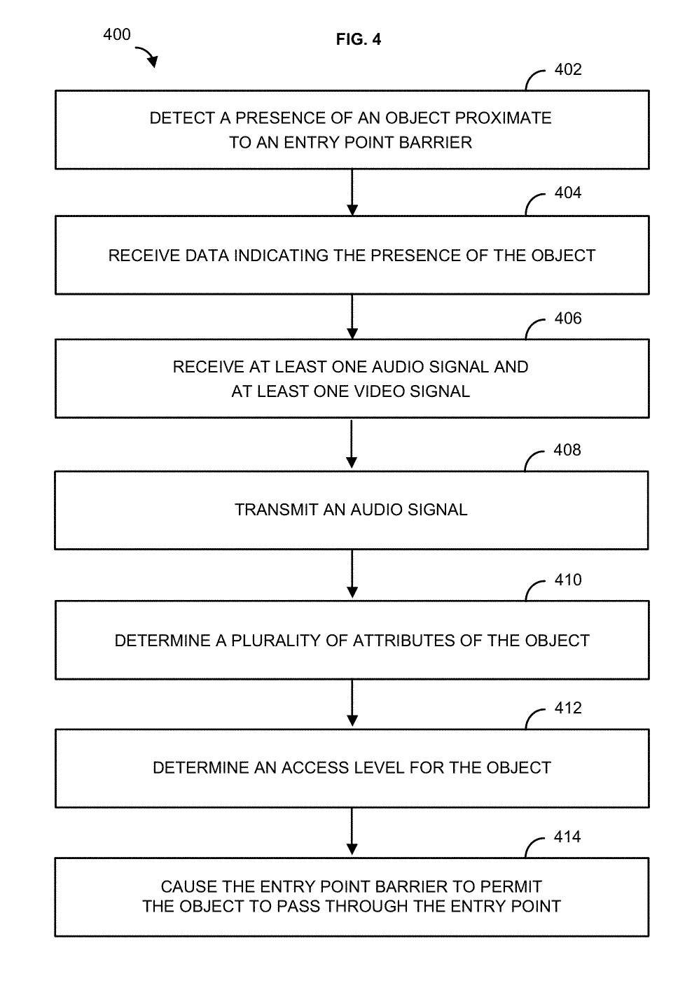

Turning now to FIG. 4, a flowchart of an exemplary method for monitoring and controlling access to a secured area is depicted. At step, 402, a presence of an object, such as a vehicle or a person, proximate to an entry point barrier to the secured area can be detected. A plurality of sensors connected to a logic unit (e.g., a programmable logic unit) can be used. At step 404, the logic unit can receive data from the plurality of sensors and, using a set of access parameters stored on a memory, make a determination whether an object is present.

The sensors may be inductive-loop sensors situated adjacent to an entry point that are interconnected by a conductive material, such as copper wiring, forming one or more loops situated on one or more sides of one or more barriers at the entry point. As a metallic object moves across or nearby the inductive-loop sensors, a change in electrical current flowing through the one or more loops can be detected and data relating to the metallic object, such as a frequency signature indicative of a vehicle type, can be transmitted to the logic unit. Other example sensors that can be used are one or more ultrasonic transducers installed near the entry point and/or affixed to the barrier. The one or more ultrasonic transducers can detect an object's presence using a series of emitted sonic pulses that originate from the ultrasonic transducers and propagate in one or more directions away from the barrier. One or more sonic pulses of the series of sonic pulses may encounter a solid object and begin propagating back toward the respective ultrasonic transducer from which they originated. Data collected by the one or more ultrasonic transducers relating to the one or more sonic pulses can be received by the logic unit and used to determine a time between the emission of the series of sonic pulses and the return of the one or more sonic pulses, thereby determining a distance that the solid object is from the barrier. For example, the logic unit may receive three sets of data collected by the one or more ultrasonic transducers over a 1.5 second timeframe wherein each set of data is collected a half-second apart (e.g., many sonic pulses may be emitted and received in each half-second timeframe). The first set of data may be used to determine that a person is 10 feet from a moveable entry point barrier that is about to, or in the process, of moving in such a way to be a danger to the person (e.g., the person may accidentally be impacted by the moveable entry point barrier as it is opening, closing, sliding, etc.). It may then be determined from the second set of data that the person is now 8 feet away from the moveable entry point barrier and is moving in a directing of travel toward the moveable entry point barrier (e.g., based on the distance determined with the first set of data and the distance determined with the second set of data). The third set of data may indicate the person is now only 6 feet away from the moveable entry point barrier. In response, the logic unit may automatically cause the moveable entry point barrier to either begin moving in a direction that is opposite its current direction of travel or to cease moving and stay in place. Simultaneously, the logic unit may cause an alarm to be sounded by one or more speakers located proximate to the moveable entry point barrier and/or cause one or more warning lights installed on or near the moveable entry point barrier to illuminate in such a way as to alert the person.

In a further example, weight sensors buried underneath a roadway or a point of ingress and/or egress near the entry point can be used. As an object passes over the weight sensors, a weight of the object can be determined at the logic unit in communication with the weight sensors, and the weight may be used as an access parameter of the plurality of access parameters. In still a further example, one or more infrared sensors can be used, which may be configured by the logic unit to determine a number of persons inside vehicles proximate to the one or more infrared sensors. Optionally, an access parameter of the plurality of access parameters may be a predetermined number of vehicle occupants. In some examples, one or more cameras may be installed at several locations surrounding the entry point, and they can be in communication with the logic unit. Further, the cameras may have integrated audio devices that are be capable of transmitting audio captured with an integrated microphone as well as receiving audio to be broadcast with an integrated speaker.

At step 406, an audio-video signal, transmitted by one or more of the audio devices situated near the entry point barrier and the one or more cameras directed toward the entry point barrier, can be received at an audio-video device, such as a touchscreen user device. The transmitted audio-video signal can be played with the user device so that a user (e.g., security personnel, custodians, law enforcement, etc.) can hear the audio and see the video in real-time as it is captured. At step 408, with an integrated microphone of the user device, a user can transmit audio (e.g., the user's voice, a recording, etc.) to be broadcast at one or more of the audio devices (e.g., the audio device closest to the detected object).

At step 410, the logic unit, using data from the sensors, may be used to determine a plurality of attributes of the detected objects and/or persons as well as one or more access parameters that can be stored on a memory of the logic unit. The plurality of attributes could be, for example, one or more physical characteristics and/or movement of a detected object, including, for example, a length, width, height, weight, and a velocity of the detected object. At step 412, using the plurality of access parameters and/or one or more of the plurality of attributes, the logic unit can determine an access level for the detected objects and/or persons. For example, one of the sensors may be a card reader that can be used in conjunction with the other sensors and/or the one or more cameras. A vehicle may approach the card reader and the vehicle driver may place his or her access card (e.g., an RFID card, an HID card, a smart card, etc.) near the card reader and in response the card reader may send the access card's credential information to the logic unit, which can determine whether the driver is authorized to enter the area (e.g., an employee of a company located at the secured area, a tenant of a building with a secured parking lot, etc.). The authorization may be determined by a set of authorized entrant data stored on the memory of the logic unit.

In one example, the card reader may alert the user device that a person is seeking entry and provide the user device with the credential information (e.g., a name stored on the card). At the user device, the user could send an authorization or a denial message to the card reader via the logic unit. In another example, the logic unit may use the credential information along with one or more attributes of the vehicle when determining whether the driver is authorized to enter. For instance, the vehicle's weight, height, length, width, or the like, may be considered. Also, using data from the one or more infrared sensors, a number of occupants in the vehicle in addition to the driver may be considered (e.g., one more access parameters may prohibit bringing guests to the secured area). Further, one or more of the cameras may be located near the card reader such that the vehicle's license plate can be viewed. The user device may analyze a frame of the video stream showing the license plate (e.g., captured by the one or more of the cameras located near the card reader) with specialized software (e.g., with optical character recognition technology) and then determine whether the license plate information corresponds with an authorized entrant (e.g., vehicle/driver is registered in a database that the user device can access with a network interface or locally on memory). Alternatively, or in addition, the license plate number may be compared by the user against a set of authorized entrant data in order to determine an access level and whether the vehicle is authorized to enter (e.g., the license plate number matches a license plate number of a vehicle that is registered with security personnel at the secured location).

At step 414, based on the determined access level, the logic unit may cause a barrier at the entry point and/or at the card reader to obstruct or not to obstruct the detected objects and/or persons from passing through the entry point. The bather located at the card reader may be an arm-type barrier, and a second wedge-type barrier that is capable of withstanding vehicle impacts may be located after the arm-type and near the entry point to the secured area. If it is determined that the object (e.g., vehicle) is authorized to enter the secured area, then the logic unit can cause the arm of the arm-type barrier to be raised so that the vehicle can proceed forward up to the wedge-type bather. At that point, an inductive-loop sensor located in front of the wedge-type barrier may detect the vehicle, and the logic unit, having already determined that the vehicle is authorized to enter, may cause the wedge-type barrier to lower and allow the vehicle to enter the secured area. As the vehicle enters the secured area, an additional inductive-loop sensor, which may be located within the secured area and near the wedge-type barrier, may detect the vehicle as it passes over the sensor's loops, and the inductive-loop sensors located outside the secured area (e.g., at the card reader and/or at the arm-type barrier) may no longer detect the vehicle's presence. In response, the logic unit may cause the arm of the arm-type barrier to lower and the wedge-type barrier to move back to its previous position (e.g., blocking access to the secured area). Further, prior to causing the barrier(s) to obstruct or not to obstruct, one or more of the audio devices located near the barrier(s) may broadcast an alert to inform persons nearby that the barrier is going to open or close (e.g., a recorded warning with instructions and/or a siren).

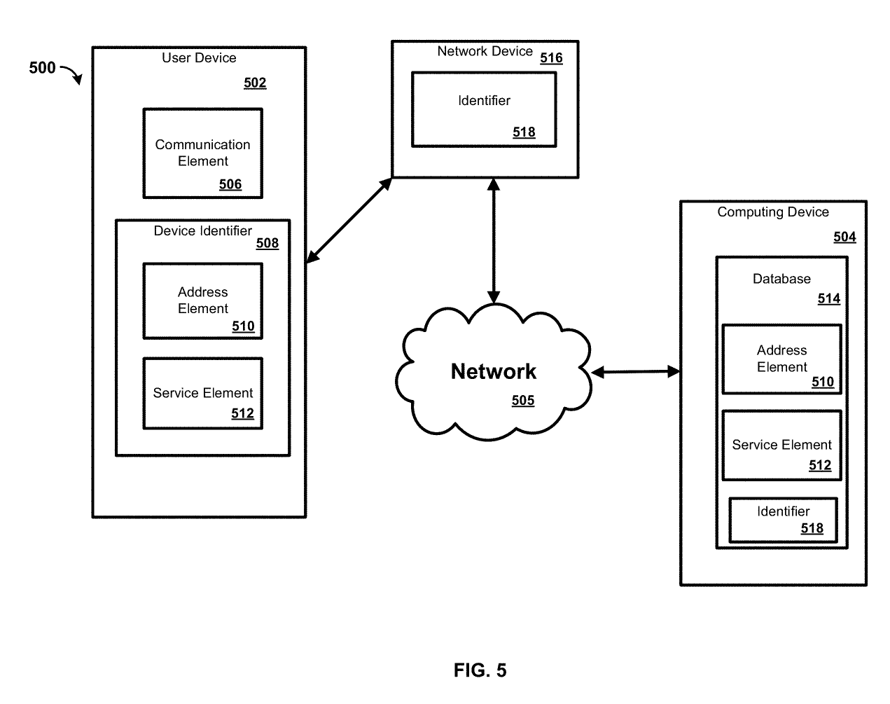

The steps described in method 400 may be accomplished using only the features described in the above description of the methods (e.g., the moveable barrier(s), plurality of sensors, conductive material, and the control unit). Alternatively, or in addition, the steps may be accomplished by a programmable logic unit (e.g., control unit 110) having a human-machine interface (e.g., user device 200) that is in communication with the control unit, the plurality of sensors (e.g., sensors 106a,b,c,d,e,f,g,h,i,j), and/or the one or more cameras (e.g., cameras 104a,b,c,d). FIG. 5 illustrates various aspects of an exemplary configuration of a system through which the present methods and systems can operate. As discussed above, the present disclosure is relevant to systems and methods for monitoring and controlling access to a secured area using a variety of equipment configurations (e.g., the barriers 100,101, the plurality of sensors 106a,b,c,d,e,f,g,h,i,j, the control unit 110, the user device 200, and the like).

Those skilled in the art will appreciate that the present methods and systems may be used in various types of networks (e.g., a closed computer network) and systems (e.g., a closed-circuit television system) that employ both digital and analog equipment. One skilled in the art will appreciate that provided herein is a functional description and that the respective functions can be performed by software, hardware, or a combination of software and hardware. As discussed above, the plurality of sensors (e.g., sensors 106a,b,c,d,e,f,g,h,i,j) and the barrier(s) (e.g., barrier 100 and/or barrier 101) may be controlled solely by a programmable logic unit (e.g., control unit 100). Alternatively, or in addition, the programmable logic unit may be in communication with a computing device 504. In such embodiments, the network and system can comprise a user device 502 (e.g., a human-machine interface such as, for example, user device 200) that is in communication with the computing device 504 and the programmable logic unit (e.g., control unit 110). The computing device 504 can be disposed locally or remotely relative to the user device 502. As an example, the user device 502 and the computing device 504 can be in communication via a private network 505 such as a local area network. Other forms of communications can be used such as wired and secured wireless telecommunication channels (e.g., an encrypted wireless network), for example. Further the one or more cameras 104a,b,c,d may communicate with the user device 502 and/or the computing device 504 via wired or wireless means (e.g., a wired or wireless closed-circuit television system). User device 502 may be a human-machine interface with a graphical user interface (e.g. user device 200) such that a user can interact with the monitoring and control system devices (e.g., sensors, cameras, and/or barrier(s)) via the programmable logic unit (e.g., control unit 110) through the computing device 504, which can act as an intermediary for communications sent to and received from the user device 502 and the programmable logic unit. Optionally, the user device 502 may be integrated with the computing device 504 as a single unit (e.g., a computer; a tablet; a mobile device with a touchscreen; and the like).

The user device 502 can be an electronic device such as a computer, a smartphone, a laptop, a tablet, or other device capable of communicating with the computing device 504. As an example, the user device 502 can comprise a communication element 506 for providing an interface to a user to interact with the user device 502 and/or the computing device 504. The communication element 506 can be any interface for presenting and/or receiving information to/from the user, such as user feedback. An example interface may be communication interface such as a web browser (e.g., Internet Explorer®, Mozilla Firefox®, Google Chrome®, Safari®, or the like). Other software, hardware, and/or interfaces can be used to provide communication between the user and one or more of the user device 502 and the computing device 504. As an example, the communication element 506 can request or query various files from a local source and/or a remote source. As a further example, the communication element 506 can transmit data to a local or remote device such as the computing device 504.

The user device 502 can be associated with a user identifier or device identifier 508. As an example, the device identifier 508 can be any identifier, token, character, string, or the like, for differentiating one user or user device (e.g., user device 502) from another user or user device. The device identifier 508 can identify a user or user device as belonging to a particular class of users or user devices. As a further example, the device identifier 508 can comprise information relating to the user device such as a manufacturer, a model or type of device, a service provider associated with the user device 502, a state of the user device 502, a locator, and/or a label or classifier. Other information can be represented by the device identifier 508.

The device identifier 508 can comprise an address element 510 and a service element 512. The address element 510 can comprise or provide an internet protocol address, a network address, a media access control (MAC) address, an Internet address, or the like. As an example, the address element 510 can be relied upon to establish a communication session between the user device 502 and the computing device 504 or other devices and/or networks. As a further example, the address element 510 can be used as an identifier or locator of the user device 502. The address element 510 can be persistent for a particular network and can be used to identify or retrieve data from the service element 512, or vice versa. As a further example, one or more of the address element 510 and the service element 512 can be stored remotely from the user device 502 and retrieved by one or more devices such as the user device 502 and the computing device 504. Other information can be represented by the service element 512.

The computing device 504 can be a server for communicating with the user device 502. As an example, the computing device 504 can communicate with the user device 502 for providing data and/or services. As an example, the computing device 504 can provide services such as network (e.g., Internet) connectivity, network printing, media management (e.g., media server), content services, streaming services, broadband services, or other network-related services. The computing device 504 can allow the user device 502 to interact with remote resources such as data, devices, and files. The computing device 504 can manage the communication between the user device 502 and a database 514 for sending and receiving data therebetween. As an example, the database 514 can store a plurality of files (e.g., various access parameters to be stored on the memory of the control unit 110), user identifiers or records, or other information. As a further example, the user device 502 can request and/or retrieve a file from the database 514. The database 514 can store information relating to the user device 502 such as the address element 510 and/or the service element 512. As an example, the computing device 504 can obtain the device identifier 508 from the user device 502 and retrieve information from the database 514 such as the address element 510 and/or the service elements 512. As a further example, the computing device 504 can obtain the address element 510 from the user device 502 and can retrieve the service element 512 from the database 514, or vice versa. Any information can be stored in and retrieved from the database 514. The database 514 can be disposed remotely from the computing device 504 and accessed via direct or indirect connection. The database 514 can be integrated with the computing system 504 or some other device or system.

One or more network devices 516 can be in communication with a network such as network 505. As an example, one or more of the network devices 516 can facilitate the connection of a device, such as user device 502, to the network 505. As a further example, one or more of the network devices 516 can be configured as a wireless access point (WAP). One or more network devices 516 can be configured to allow one or more wireless devices to connect to a wired and/or wireless network using Wi-Fi, Bluetooth or any desired method or standard.

The network devices 516 can be configured as a local area network (LAN). As an example, one or more network devices 516 can comprise a dual band wireless access point. As an example, the network devices 516 can be configured with a first service set identifier (SSID) (e.g., associated with a user network or private network) to function as a local network for a particular user or users. As a further example, the network devices 516 can be configured with a second service set identifier (SSID) (e.g., associated with a public/community network or a hidden network) to function as a secondary network or redundant network for connected communication devices.

One or more network devices 516 can comprise an identifier 518. As an example, one or more identifiers can be or relate to an Internet Protocol (IP) Address IPV4/IPV6 or a media access control address (MAC address) or the like. As a further example, one or more identifiers 518 can be a unique identifier for facilitating communications on the physical network segment. Each of the network devices 516 can comprise a distinct identifier 518. As an example, the identifiers 518 can be associated with a physical location of the network devices 516.

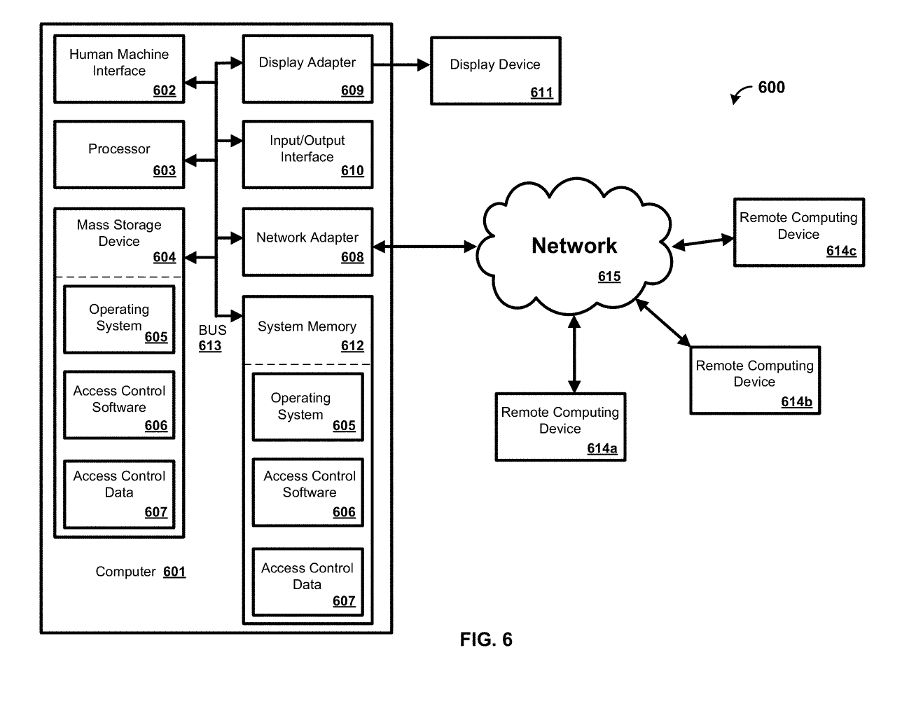

In an aspect, the systems and methods can be implemented on a computer 601 as illustrated in FIG. 6 and described below. By way of example, the user device 502 of FIG. 5 (e.g., a human-machine interface such as, for example, user device 200) can be a computer as illustrated in FIG. 6. Similarly, the systems and methods disclosed can utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present systems and methods can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed systems and methods can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, access control software 606, access control data 607, a network adapter 608, the system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the access control data 607 and/or program modules such as the operating system 605 and the access control software 606 that are immediately accessible to and/or are presently operated on by the one or more processors 603.

In another aspect, the computer 601 can also comprise other removable/non-removable, volatile/non-volatile computer storage media. By way of example, FIG. 6 illustrates the mass storage device 604 which can provide non-volatile storage of computer code, computer readable instructions, data structures, program modules, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, the operating system 605 and the access control software 606. Each of the operating system 605 and the access control software 606 (or some combination thereof) can comprise elements of the programming and the access control software 606. The access control data 607 can also be stored on the mass storage device 604. The access control data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, the display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), or a projector. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614a,b,c. By way of example, a remote computing device can be a personal computer, portable computer, smartphone, a server, a router, a network computer, a peer device or other common network node, and so on. Logical connections between the computer 601 and a remote computing device 614a,b,c can be made via a network 615, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the one or more processors 603 of the computer. An implementation of the access control software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The systems and methods can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the systems and methods have been described in connection with preferred embodiments and specific examples, it is not intended that the scope be limited to the particular embodiments set forth, as the embodiments herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and/or the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system, comprising:
a moveable barrier situated at an entry point;
one or more cameras adjacent to the entry point;
a plurality of sensors configured to:
detect a presence of one or more objects near the entry point; and
collect data relating to one or more attributes of the one or more objects;
an audio-video device configured to transmit and receive audio signals and video signals;
one or more passive audio devices configured to:
output audio signals received by the audio-video device; and
transmit audio signals to the audio-video device; and
a control unit configured to:
receive data from each of the plurality of sensors;
cause each of the one or more cameras to capture one or more images and to transmit the one or more images to the audio-video device;
cause the one or more passive audio devices to transmit audio signala to the audio-video device; and
cause the moveable barrier to block access through the entry point based on a determination that the one or more attributes of the one or more objects do not satisfy at least one of a plurality of access parameters.

2. The system of claim 1, wherein the plurality of sensors are inductive-loop sensors each configured to detect a presence of a metallic object.

3. The system of claim 1, wherein the plurality of sensors are ultrasonic transducers.

4. The system of claim 3, wherein the ultrasonic transducers are situated proximate to the entry point and are configured to:
emit a series of sonic pulses, wherein the sonic pulses travel away from the ultrasonic transducers, encounter a solid object, and return toward the ultrasonic transducers;
detect one or more of the series of sonic pulses;
determine an amount of time between the emission of the one or more of the sonic pulses and the detection of the one or more of the sonic pulses; and
detect a presence of an object based on the amount of time between the emission of the one or more of the sonic pulses and the detection of the one or more of the sonic pulses.

5. The system of claim 1, wherein the attributes of the object comprise one or more of a weight, a length, a height, a width, or a shape.

6. The system of claim 1, wherein the audio-video device is operated by a user.

7. The system of claim 1, wherein at least one of the plurality of sensors is a weight sensor situated proximate to the entry point, and wherein at least one of the plurality of access parameters comprises an amount of weight.

8. The system of claim 1, wherein the object is a vehicle, wherein at least one of the plurality of sensors is an infrared sensor configured to determine a number of persons within a view of the at least one sensor, and wherein at least one of the plurality of access parameters comprises a predetermined number of persons.

9. The system of claim 1, wherein at least one of the plurality of sensors is configured to receive, via access card placed near the at least one sensor, a set of data comprising personnel credentials, and wherein at least one of the plurality of access parameters comprises a set of authorized personnel credentials.

10. The system of claim 1, wherein the one or more passive audio devices are situated at various locations surrounding the entry point and each are further configured to detect movement of an object and to output an audio signal transmitted by the audio-video device when movement is detected.

11. The system of claim 1, wherein the control unit is further configured to cause the one or more passive audio devices to each output an audio signal prior to the moveable barrier blocking access to the entry point.

12. A method, comprising:
detecting, by at least one of a plurality of sensors, a presence of an object proximate to an entry point barrier;
receiving, from the at least one of the plurality of sensors, data indicating the presence of the object;
receiving at least one audio signal transmitted by one or more of a plurality of passive audio devices situated near the entry point barrier and at least one video signal transmitted by one or more cameras directed toward the entry point barrier;
transmitting an audio signal to one or more of the plurality of passive audio devices;
determining, based on the data indicating the presence of the object, a plurality of attributes of the object;
determining, based on the plurality of attributes of the object and one or more access parameters, an access level for the object; and
causing the entry point barrier to move to a position to permit the object to pass through the entry point.

13. The method of claim 12, wherein the plurality of sensors are inductive-loop sensors configured to detect a presence of a metallic object.

14. The method of claim 12, wherein the plurality of sensors are ultrasonic transducers.

15. The method of claim 14, further comprising:
emitting, via the ultrasonic transducers, a series of sonic pulses, wherein the sonic pulses travel away from the ultrasonic transducers, encounter a solid object, and return toward the ultrasonic transducers;
detecting one or more of the series of sonic pulses;
determining an amount of time between the emission of the one or more of the sonic pulses and the detection of the one or more of the sonic pulses; and
detecting a presence of an object based on the amount of time between the emission of the one or more of the sonic pulses and the detection of the sonic pulses.

16. The method of claim 12, wherein the attributes of the object comprise one or more of a weight, a length, a height, a width, or a shape.

17. The method of claim 12, wherein the object is a vehicle.

18. The method of claim 17, further comprising:
determining, based on data received from an infrared sensor, a number of occupants inside the vehicle; and
determining, based on the number of occupants and the one or more access parameters, the access level for the vehicle.

19. The method of claim 12, wherein the audio-video device is operated by a user.

20. The method of claim 12, wherein at least one of the plurality of sensors is a weight sensor situated proximate to the entry point, and wherein at least one of the plurality of access parameters comprises an amount of weight.
